(19) United States
(12) Patent Application Publication
(10) Pub. No.: US 2022/0211112 A1
(43) Pub. Date: Jul. 7, 2022

(54) ELECTRONIC VAPOR PROVISION SYSTEM WITH OPTICAL WIRELESS COMMUNICATIONS

(71) Applicant: Nicoventures Trading Limited, London (GB)

(72) Inventors: Patrick MOLONEY, London (GB); Darryl BAKER, London (GB); Anton KORUS, London (GB)

(21) Appl. No.: 17/594,749

(22) PCT Filed: May 1, 2020
(86) PCT No.: PCT/GB2020/051081

§ 371 Date: Oct. 28, 2021

(30) Foreign Application Priority Data
May 3, 2019 (GB) 1906243.9

(51) Int. Cl. A24F 40/50; A24F 40/10; A24F 40/65

(52) U.S. Cl. CPC A24F 40/50; A24F 40/65; A24F 40/10

(57) ABSTRACT

An electronic vapor provision system comprising a light source configured to emit light, and a controller comprising a data processor configured to generate transmission data, wherein the controller is configured to control the light source to emit an optical signal for transmitting the transmission data.

### PRIORITY CLAIM

The present application is a National Phase entry of PCT Application No. PCT/GB2020/051081, filed May 1, 2020, which claims priority from Great Britain Application No. 1906243.9, filed May 3, 2019, each of which is hereby fully incorporated herein by reference.

### TECHNICAL FIELD

The present disclosure relates to a data communication system and method for electronic vapor provision system such as electronic nicotine delivery systems (e.g. e-cigarettes) using optical wireless communication.

### BACKGROUND

Electronic vapor provision systems, such as e-cigarettes and other aerosol delivery systems, generally contain a reservoir of liquid which is to be vaporized, typically nicotine (this is sometimes referred to as an “e-liquid”). When a user inhales on the device, an electrical (e.g. resistive) heater is activated to vaporize a small amount of liquid, in effect producing an aerosol which is therefore inhaled by the user. The liquid may comprise nicotine in a solvent, such as ethanol or water, together with glycerine or propylene glycol to aid aerosol formation, and may also include one or more additional flavors. The skilled person will be aware of many different liquid formulations that may be used in e-cigarettes and other such devices. The practice of inhaling vaporized liquid in this manner is commonly known as ‘vaping’.

In the use of electronic vapor provision systems, there can be information gathered by the device relating to the status of that system. This information may be useful to a user of an electronic vapor provision system such as an electronic nicotine delivery (“END”) device in relation to information such as battery charge level or information relating to remaining nicotine source level such as a puff count and/or total puff duration value. Some information may relate to error codes generated by the device, or there may be information useful to a user aiming to regulate his or her reliance upon nicotine. Such information may also be of use to some form of administrator entity, for example allowing logging of numbers and types of error occurrences. The inventors have devised approaches for accessing such information in a secure and energy-efficient manner.

### SUMMARY

Particular aspects and embodiments are set out in the appended independent and dependent claims.

Viewed from one perspective, there is provided an apparatus, a system and a method for communication from an electronic vapor provision system using light communication such as optical signal.

In a particular approach, there is provided an electronic vapor provision system, comprising: a light source configured to emit light; and a controller comprising a data processor configured to generate transmission data, wherein the controller is configured to control the light source to emit an optical signal for transmitting the transmission data.

In other words, there is provided an electronic vapor provision system comprising a light source and a controller configured to enable optical wireless communication by controlling the light source to transmit data collected by the electronic vapor provision system through the use of optical carriers, such as visible, infrared, and ultraviolet band.

In another particular approach, there is provided a system comprising:

an electronic vapor provision system, comprising: a light source configured to emit light; and a controller comprising a data processor configured to generate transmission data, wherein the controller is configured to control the light source to emit an optical signal for transmitting the transmission data; and

a reading device comprising: an optical signal receiver configured to receive the optical signal emitted from the electronic vapor provision system, and a data processor configured to interpret the received optical signal.

The optical signal receiver may comprise a light sensor. Optical signal is a machine readable signal which codes the relevant data. Thus, interpreting the received optical signal can also be considered as decoding the optical signal.

In another particular approach, there is provided a method comprising: generating transmission data at an electronic vapor provision system; emitting an optical signal for transmitting the transmission data from the electronic vapor provision system; receiving the emitted optical signal at a reading device; processing received optical signal for interpreting the received transmission data.

### BRIEF DESCRIPTION OF THE DRAWINGS

Embodiments of the present invention will now be described by way of example with reference to the accompanying drawings, in which:

FIG. 1 is a schematic (exploded) diagram of an e-cigarette in accordance with some embodiments of the disclosure.

FIG. 2 is a schematic diagram of the main electrical/electronic components of the e-cigarette of FIG. 1 in accordance with some embodiments of the disclosure.

FIG. 3 is a schematic diagram of a reader in accordance with some embodiments of the disclosure.

FIG. 4 is a schematic diagram of a system comprising electronic vapor provision system, a reader and a remote network service.

FIG. 5 is a flow diagram of a method of light communication between the electronic vapor provision system and a reader, and the reader communicating with the remote network service.

### DETAILED DESCRIPTION OF THE DRAWINGS

A data communication system and method for electronic vapor provision system such as electronic nicotine delivery systems (e.g. e-cigarettes) are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

As described above, the present disclosure relates to a data communication system and method for electronic vapor provision system, such as an e-cigarette. Throughout the following description the term “e-cigarette” is used; however, this term may be used interchangeably with electronic vapor provision system, aerosol delivery device, and other similar terminology.

The present disclosure describes an e-cigarette configured to vaporize a liquid to generate an aerosol through the application of heat for the sake of a concrete example. However, it should be appreciated that the techniques disclosed in the present application are not limited to this technology. For example, in some implementations, the e-cigarette is a heating product which releases one or more compounds by heating, but not burning, a substrate material. The substrate material is an aerosolizable material which may be for example tobacco or other non-tobacco products, which may or may not contain nicotine. In one embodiment, the heating product is a tobacco heating product. More generally, the e-cigarette of the present disclosure is configured to aerosolize (via heating or any other suitable means) one or more aerosolizable materials which may include liquid and/or solid components.

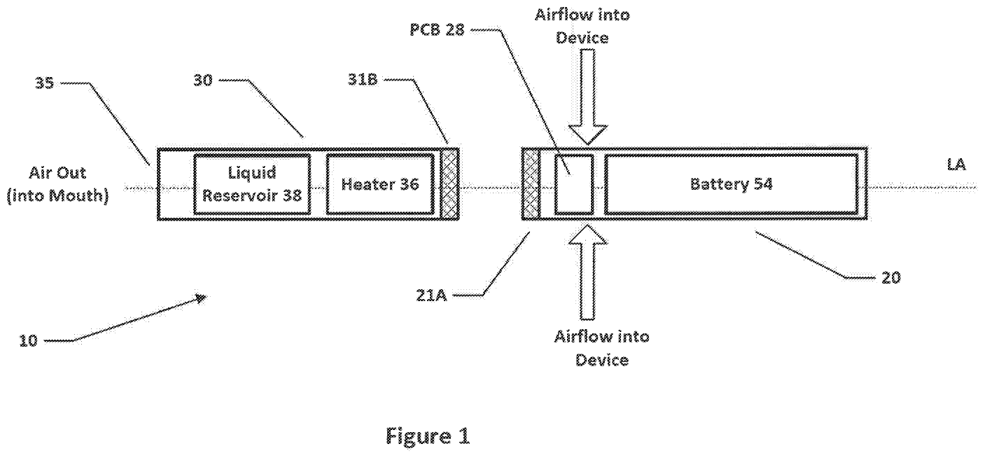

FIG. 1 is a schematic diagram of an e-cigarette 10 in accordance with some embodiments of the disclosure (not to scale). The e-cigarette comprises a body or control unit 20 and a cartomizer 30. The cartomizer 30 includes a reservoir 38 of liquid, typically including nicotine, a heater 36, and a mouthpiece 35. The e-cigarette 10 has a longitudinal or cylindrical axis which extends along the center-line of the e-cigarette from the mouthpiece 35 at one end of the cartomizer 30 to the opposing end of the control unit 20 (usually referred to as the tip end). This longitudinal axis is indicated in FIG. 1 by the dashed line denoted LA.

The liquid reservoir 38 in the cartomizer may hold the (e-)liquid directly in liquid form, or may utilize some absorbing structure, such as a foam matrix or cotton material, etc, as a retainer for the liquid. The liquid is then fed from the reservoir 38 to be delivered to a vaporizer comprising the heater 36. For example, liquid may flow via capillary action from the reservoir 38 to the heater 36 via a wick (not shown in FIG. 1).

The control unit 20 includes a re-chargeable cell or battery 54 to provide power to the e-cigarette 10 (referred to hereinafter as a battery) and a printed circuit board (PCB) 28 and/or other electronics for generally controlling the e-cigarette.

The control unit 20 and the cartomizer 30 are detachable from one another, as shown in FIG. 1, but are joined together when the device 10 is in use, for example, by a screw or bayonet fitting. The connectors on the cartomizer 30 and the control unit 20 are indicated schematically in FIG. 1 as 31B and 21A respectively. This connection between the control unit and cartomizer provides for mechanical and electrical connectivity between the two.

When the control unit is detached from the cartomizer, the electrical connection 21A on the control unit that is used to connect to the cartomizer may also serve as a socket for connecting a charging device (not shown). The other end of this charging device can be plugged into a USB socket to re-charge the battery 54 in the control unit of the e-cigarette. In other implementations, the e-cigarette may be provided (for example) with a cable for direct connection between the electrical connection 21A and a USB socket.

The control unit is provided with one or more holes for air inlet adjacent to PCB 28. These holes connect to an air passage through the control unit to an air passage provided through the connector 21A. This then links to an air path through the cartomizer 30 to the mouthpiece 35. Note that the heater 36 and the liquid reservoir 38 are configured to provide an air channel between the connector 31B and the mouthpiece 35. This air channel may flow through the center of the cartomizer 30, with the liquid reservoir 38 confined to an annular region around this central path. Alternatively (or additionally) the airflow channel may lie between the liquid reservoir 38 and an outer housing of the cartomizer 30.

When a user inhales through the mouthpiece 35, air is drawn into the control unit 20 through the one or more air inlet holes. This airflow (or the associated change in pressure) is detected by a sensor, e.g. a pressure sensor, which in turn activates the heater 36 to vaporize the nicotine liquid fed from the reservoir 38. The airflow passes from the control unit into the vaporizer, where the airflow combines with the nicotine vapor. This combination of airflow and nicotine vapor (in effect, an aerosol) then passes through the cartomizer 30 and out of the mouthpiece 35 to be inhaled by a user. The cartomizer 30 may be detached from the control unit and disposed of when the supply of nicotine liquid is exhausted, or when the user wishes to change the liquid being vaporized, and then replaced with another cartomizer.

It will be appreciated that the e-cigarette 10 shown in FIG. 1 is presented by way of example only, and many other implementations may be adopted. For example, in some implementations, the cartomizer 30 is split into a cartridge containing the liquid reservoir 38 and a separate vaporizer portion containing the heater 36. In this configuration, the cartridge may be disposed of after the liquid in reservoir 38 has been exhausted, but the separate vaporizer portion containing the heater 36 is retained. Alternatively, an e-cigarette may be provided with a cartomizer 30 as shown in FIG. 1, or else constructed as a one-piece (unitary) device, but the liquid reservoir 38 is in the form of a (user-)replaceable cartridge. Further possible variations are that the heater 36 may be located at the opposite end of the cartomizer 30 from that shown in FIG. 1, i.e. between the liquid reservoir 38 and the mouthpiece 35, or else the heater 36 is located along a central axis LA of the cartomizer, and the liquid reservoir is in the form of an annular structure which is radially outside the heater 35.

The skilled person will also be aware of a number of possible variations for the control unit 20. For example, airflow may enter the control unit at the tip end, i.e. the opposite end to connector 21A, in addition to or instead of the airflow adjacent to PCB 28. In this case the airflow would typically be drawn towards the cartomizer along a passage between the battery 54 and the outer wall of the control unit. Similarly, the control unit may comprise a PCB located on or near the tip end, e.g. between the battery and the tip end. Such a PCB may be provided in addition to or instead of PCB 28.

Furthermore, an e-cigarette may support charging at the tip end, or via a socket elsewhere on the device, in addition to or in place of charging at the connection point between the cartomizer and the control unit. (It will be appreciated that some e-cigarettes are provided as essentially integrated units, in which case a user is unable to disconnect the cartomizer from the control unit). Other e-cigarettes may also support wireless (induction) charging, in addition to (or instead of) wired charging.

The above discussion of potential variations to the e-cigarette shown in FIG. 1 is by way of example. The skilled person will be aware of further potential variations (and combination of variations) for the e-cigarette 10.

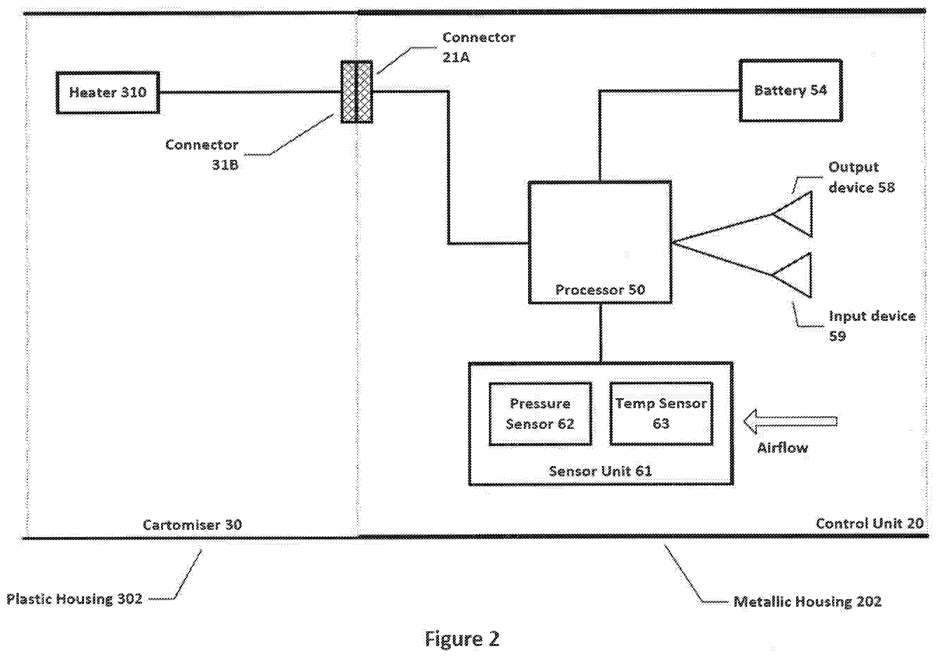

FIG. 2 is a schematic diagram of the main functional components of the e-cigarette 10 of FIG. 1 in accordance with some embodiments of the disclosure. FIG. 2 is primarily concerned with electrical connectivity and functionality—it is not intended to indicate the physical sizing of the different components, nor details of their physical placement within the control unit 20 or cartomizer 30. In addition, it will be appreciated that at least some of the components shown in FIG. 2 located within the control unit 20 may be mounted on the circuit board 28. Alternatively, one or more of such components may instead be accommodated in the control unit to operate in conjunction with the circuit board 28, but not physically mounted on the circuit board itself. For example, these components may be located on one or more additional circuit boards, or they may be separately located (such as battery 54).

As shown in FIG. 2, the cartomizer contains heater 310 which receives power through connector 31B. The control unit 20 includes an electrical socket or connector 21A for connecting to the corresponding connector 31B of the cartomizer 30 (or potentially to a USB charging device). This then provides electrical connectivity between the control unit 20 and the cartomizer 30.

The control unit 20 further includes a sensor unit 61, which is located in or adjacent to the air path through the control unit 20 from the air inlet(s) to the air outlet (to the cartomizer 30 through the connector 21A). The sensor unit contains a pressure sensor 62 and temperature sensor 63 (also in or adjacent to this air path). The control unit further includes a battery 54, and input and output devices 59, 58.

The operations of the processor 50 and other electronic components, such as the pressure sensor 62, are generally controlled at least in part by software programs running on the processor (or other components). Such software programs may be stored in non-volatile memory, such as ROM, which can be integrated into the processor 50 itself, or provided as a separate component. The processor 50 may access the ROM to load and execute individual software programs as and when required. The processor 50 also contains appropriate communications facilities, e.g. pins or pads (plus corresponding control software), for communicating as appropriate with other devices in the control unit 20, such as the pressure sensor 62.

The input device(s) 59 may be provided in various forms. For example, an input device (or devices) may be implemented as buttons on the outside of the e-cigarette—e.g. as mechanical, electrical or capacitor (touch) sensors. Some devices may support blowing into, or alternatively inhaling on, the e-cigarette as an input mechanism (such blowing may be detected by pressure sensor 62, which would then be also acting as a form of input device 59), and/or connecting/disconnecting the cartomizer 30 and control unit 20 as another form of input mechanism. Again, it will be appreciated that a given e-cigarette may include input devices 59 to support multiple different input modes.

As noted above, the e-cigarette 10 provides an air path from the air inlet through the e-cigarette, past the pressure sensor 62 and the heater 310 in the cartomizer 30 to the mouthpiece 35. Thus when a user inhales on the mouthpiece of the e-cigarette, the processor 50 detects such inhalation based on information from the pressure sensor 62. In response to such a detection, the CPU supplies power from the battery 54 to the heater, which thereby heats and vaporizes the nicotine from the liquid reservoir 38 for inhalation by the user.

In order to provide more fine-grained control of the amount of power flowing from the battery 54 to the heater 310, a pulse-width modulation (PWM) scheme may be adopted using an FET. The use of PWM provides an effective power to the heater which is given by the nominal available power (based on the battery output voltage and the heater resistance) multiplied by the duty cycle. The processor 50 may, for example, utilize a duty cycle of 1 (i.e. full power) at the start of an inhalation to initially raise the heater 310 to its desired operating temperature as quickly as possible. Once this desired operating temperature has been achieved, the processor 50 may then reduce the duty cycle to some suitable value in order to maintain the heater 310 at the desired operating temperature.

The output device 58 comprises a light source configured to emit light. In one embodiment, the output device 58 is a light emitting diode (LED). The LED is controlled by the processor 50, which is also referred to as a controller. The processor 50 controls the LED to emit an optical signal, which is machine-distinguishable, for transmitting transmission data. Such transmission data may convey the information on the status of the device gathered by the END device and stored in a data storage in the processor 50. Such data may be collected by the sensor unit 61.

A non-exhaustive list of examples of data on the status of the device includes:
Puff Count (the number of aerosol delivery operations carried out by the device, definable as total operations for the device or operations since a change event such as a new aerosol content cartridge being inserted)
Puff Duration (the average duration or total summed duration of aerosol delivery operations, typically over the same duration as the Puff Count)
Battery Charges (the number of battery charge/discharge cycles carried out on the device)
Average Battery percentage before charge (an indication of the average percentage charge value at the time that a charge is commenced)
Overheat Protection (the number of times that overheat protection function has been engaged in the device)
Error Codes (any error codes currently indicated by the device and/or an occurrence history of error codes in the device)
Puff too Short (an indication of aerosol delivery operations that fall below a threshold duration to ensure that aerosol content is actually delivered)
Cartomizer Used (an indication of an aerosol content cartridge currently installed in the device)
Puffs per power profile (a count of aerosol delivery operations for each of a number of different power profiles, for example high, medium and low)
Current Power Settings (an indication of current power settings as presently set for use in a next aerosol delivery operation)
Charged duration (an indication of the length of time for which the device has held sufficient charge for aerosol delivery operations)
Battery Threshold before charge (an indication of remaining battery charge, expressed as a percentage, hours of standby, and/or number of aerosol delivery operations at present power settings, etc)
Boot/Uptime Time(s) (an indication of a number of power-on cycles and/or a duration of power on status)
Product Type (an identifier of a product type of the device)
Batch Number (an identifier of a batch number of the device)
Serial Number (an identifier of a serial number of the device)
Duration of Device On time (an indication of a duration of power on status)
Duration of Device Off time (an indication of a duration of power off status)
Device/Coil temperature (an indication of a current and/or history of the device temperature and/or a temperature of a heater coil used for aerosol generation)

As will be appreciated, a wide variety of such data relating to the current and historical usage/status of the device may be created and used depending on the requirements of the aerosol delivery device and/or remote network service. For example, in an arrangement where an application provided at the remote network service is concerned with successful operation of the device and providing error feedback to a user or an administrator, the data relating to error codes, physical status (temperature, battery, uptime etc.) and device identify (product, batch, serial, etc.) may be emphasized or signaled first.

The output device may include more than one LED, where these LEDs are the same or different colors (or multi-colored). In the case of multi-colored LEDs, different colors are obtained by switching red, green or blue LEDs on, optionally at different relative brightnesses to give corresponding relative variations in color. Where red, green and blue LEDs are provided together, a full range of colors is possible, whilst if only two out of the three red, green and blue LEDs are provided, only a respective sub-range of colors can be obtained.

It is not necessary for the light source to emit only visible light. Any part of the light spectrum may be utilized to emit optical signal for transmitting transmission data, for example ultraviolet (UV) or infrared (IR) light. Accordingly, the output device 58 may be an LED which emits UV or IR light, or any other light within the light spectrum. Accordingly, the device or unit intended to receive the transmitted light is provided with a corresponding detector (i.e., sensor unit 61) configured to detect wavelengths of at least the transmitted light.

Signaling using IR light provides improved signal to noise ratio than when using visible light. Further, IR light is less influenced by ambient conditions such as surrounding light sources which allows it to be independent of the environment of the END device during data transfer.

The output device(s) 58 may further provide haptic or audio output, and may include for example a vibrator and/or a speaker. The output from the output device may be used to indicate to the user various conditions or states within the e-cigarette, such as a low battery warning. Different output indications may be used for indicating different states or conditions. For example, if the output device 58 includes one or more visible lights, different states or conditions may be represented by using different colors, pulses of light or continuous illumination, different pulse durations, and so on. For example, one indicator light might be utilized to show a low battery warning, while another indicator light might be used to indicate that the liquid reservoir 58 is nearly depleted.

It is noted that this indication differs from emitting an optical signal for transmitting the transmission data generated by the processor 50. For example, the optical signal for transmitting the transmission data is machine readable. The light source is configured to flash on and off in a binary manner at a predetermined frequency to form the optical signal. The predetermined frequency may be set based on several factors including but not limited to: the amount of data to be communicated; the desired time limit for achieving data transfer; the number of channels (e.g., colors) used to communicate the data; the physical mechanism to achieve the pulsing of the light; and the temporal resolution of the sensor unit. The predetermined frequency is therefore set with at least these factor in mind. For example, if only a few bits of data are to be transmitted, then a relatively low frequency pulsed signal can be used. The skilled person is able to select a suitable frequency and suitable output units 58 and sensor units 61 for the application at hand.

Transmission data generated by the processor for the optical signal also differs from the data for controlling the LEDs to immediately indicate to the user the state of the e-cigarette. In some cases, the LEDs for the optical signal may differ from those that provide visible indication to the user (particularly if IR LEDs are used for the optical signaling). For example, once a threshold of a puff count has been reached (for example 2000 puffs taken since cartridge has been inserted), the LED which emits visible light may indicate to the user that an optical signal(s) needs to be sent or that the cartridge needs to be replaced. Then, the LED may emit an optical signal, which cannot be interpreted by the user (due to the high frequency), but can be read by an appropriate reader. Typical frequencies which cannot be detected/distinguished by a user may be on the order of 60 Hz or greater.

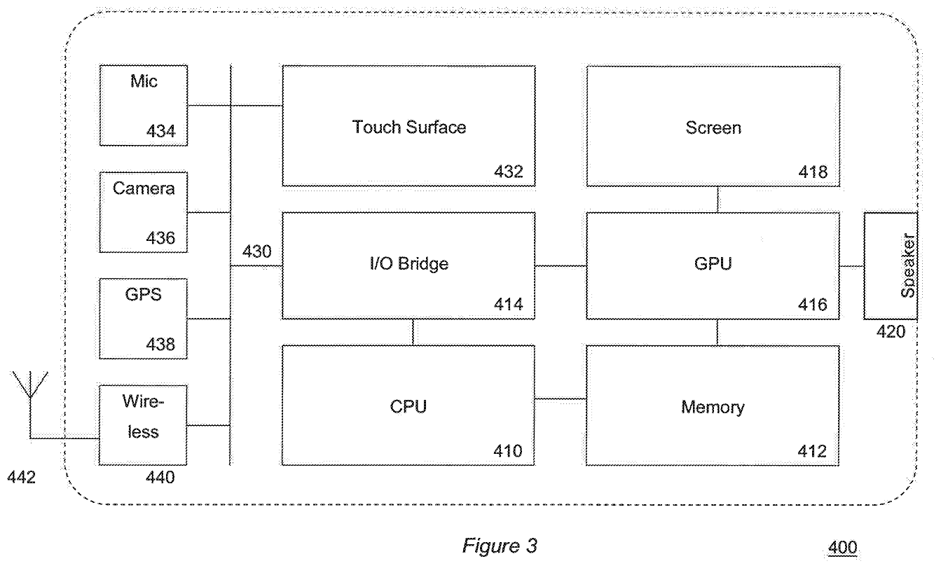

The optical signal may be received by a reading device to interpret the received optical signal. The reading device may be a mobile communication device 400, comprising a camera for detecting the optical signal. A typical mobile communication device 400 is illustrated in FIG. 3. By using the optical signaling, the e-cigarette is able to communicate with the mobile communication device 400.

Light sources, particularly visible light sources, are ubiquitously provided in electronic vapor provision systems. Therefore, it is not necessary for additional components dedicated to wireless data communication to be included in the electronic vapor provision system. This is particularly advantageous as electronic vapor provision systems have limited space within the device and it is desirable for the systems to be light and compact. In other words, the electronic vapor provision system may utilize visible light so as to implement visible light communication.

Further, less power is required for activating and controlling light sources than activating and controlling other more complex types of wireless communication devices, such as Bluetooth or Wifi.

Unlike in other types of wireless communication, communication using optical signal as in the present invention does not require a two-way communication. The electronic vapor provision device emits light to represent an optical signal, which is received by a reader. The electronic vapor provision device itself is not required to receive anything from the reader in order to send the optical signal. Thus, a more secure communication against any virus or external configuration via the wireless communication can be achieved via this unidirectional communication method. Any malicious virus or non-authorized external configuration being carried out on the electronic vapor provision device can be dangerous, as this could lead to overheating or even explosion of the electronic vapor provision system.

The reading device may be a smartphone with a camera or photo receiving diode, or any other devices comprising a light sensor for receiving the optical signal. Thus, it can be seen that in the present invention pre-existing systems are utilized to enable the light communication, thereby providing a potentially universal communication route that can be implemented in most types of electronic vapor provision systems.

As can be seen in FIG. 3, a typical smartphone 400 comprises a central processing unit (CPU) (410). The CPU may communicate with components of the smart phone either through direct connections or via an I/O bridge 414 and/or a bus 430 as applicable.

In the example shown in FIG. 3, the CPU communicates directly with a memory 412, which may comprise a persistent memory such as for example Flash® memory for storing an operating system and applications (apps), and volatile memory such as RAM for holding data currently in use by the CPU. Typically persistent and volatile memories are formed by physically distinct units (not shown). In addition, the memory may separately comprise plug-in memory such as a microSD card, and also subscriber information data on a subscriber information module (SIM) (not shown).

The smart phone may also comprise a graphics processing unit (GPU) 416. The GPU may communicate directly with the CPU or via the I/O bridge, or may be part of the CPU. The GPU may share RAM with the CPU or may have its own dedicated RAM (not shown) and is connected to the display 418 of the mobile phone. The display is typically a liquid crystal (LCD) or organic light-emitting diode (OLED) display, but may be any suitable display technology, such as e-ink. Optionally the GPU may also be used to drive one or more loudspeakers 420 of the smart phone.

Alternatively, the speaker may be connected to the CPU via the I/O bridge and the bus. Other components of the smart phone may be similarly connected via the bus, including a touch surface 432 such as a capacitive touch surface overlaid on the screen for the purposes of providing a touch input to the device, a microphone 434 for receiving speech from the user, one or more cameras 436 for capturing images, a global positioning system (GPS) unit 438 for obtaining an estimate of the smart phone's geographical position, and wireless communication means 440.

The wireless communication means 440 may in turn comprise several separate wireless communication systems adhering to different standards and/or protocols, such as Bluetooth® (standard or low-energy variants), near field communication and Wi-Fi®, and also phone based communication such as 2G, 3G and/or 4G.

The systems are typically powered by a battery (not shown) that may be chargeable via a power input (not shown) that in turn may be part of a data link such as USB (not shown).

It will be appreciated that different smartphones may include different features (for example a compass or a buzzer) and may omit some of those listed above (for example a touch surface).

Thus more generally, in an embodiment of the present invention a suitable reading device such as smart phone 400 will comprise a CPU and a memory for storing and running an app, a light sensor such as a camera for receiving the optical signal emitted by the aerosol delivery device, an output means for providing representations to the user the interpretation of the optical signal, and wireless communication means operable to access remote network service. It will be appreciated however that the remote device may be a device that has these capabilities, such as a tablet, laptop, smart TV or the like.

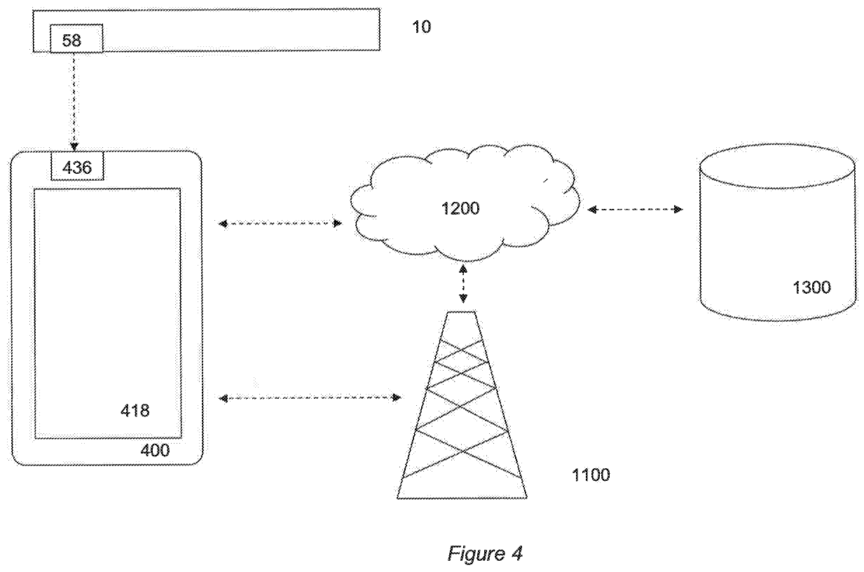

FIG. 4 illustrates a system comprising an e-cigarette 10, a mobile communication device 400 such as a smart phone, tablet, laptop, smartwatch, etc., and a remote network service.

As can be seen in FIG. 4, the output device 58, which comprises a light source as discussed above, of the e-cigarette 10 emits lights in a way to form an optical signal, which is received by the camera 436 of the smart phone 400. Such communications can be used for a wide range of purposes, for example, to retrieve usage and/or diagnostic data from the e-cigarette 10.

The mobile communication device 400 may communicate with a remote network service 1300 via a base station 1100 using mobile data to connect to the internet 1200 and thereon to the remote network service 1300, or via a Wi-Fi® access point (not shown) to connect directly to the internet 1200 and thereon to the remote network service 1300.

There may be an application (app) running on the smartphone 400 (it could be other suitable mobile communication device such as tablet, laptop, smartwatch etc) to assist in more easily uploading or accessing the data onto/from the remote network service 1300.

The remote network service 1300 comprises various databases which include, for example, messages corresponding to various optical signals, information about each user and about the electronic vapor provision device.

Thus, the smartphone 400 is able to interpret the received optical signal data by accessing a decoding database of the remote network service 1300. For example, a corresponding data of the optical signal may be matched with a message or information that the optical signal data represents. The smartphone 400 is then able to represent, in a user legible form, the interpreted information of the optical signal received on its display.

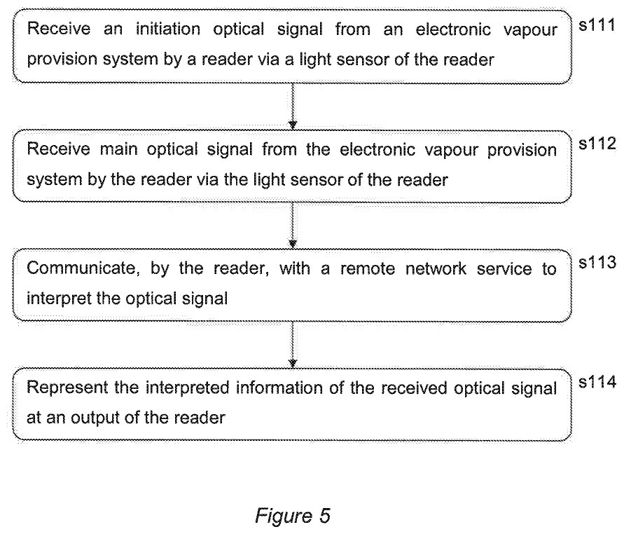

FIG. 5 illustrates a flow diagram of a method of light communication between the electronic vapor provision system and a reader, and the reader communicating with the remote network service.

In step 111, the reader, such as a smartphone 400, receives an initiation optical signal from an electronic vapor provision system at the light sensor, such as a camera 436, of the smartphone 400. The initiation optical signal, which acts as a header, marks the start of the main optical signal. Using the initiation optical signal, the reader is able to distinguish the main portion of the optical signal which actually includes information relating to the status of the electronic vapor provision device. The initiation optical signal and the main optical signal may be sent consecutively. The optical signal may be emitted automatically by the electronic provision system where an error is identified by the electronic provision system. In other cases, the emission of optical signal may be initiated by the user by configuring the electronic provision system. For example, the input of the electronic provision system, such as mechanical buttons, may be toggled to initiate the emission of optical signal relating to various information of the electronic provision system.

In step 112, the reader further receives main optical signal from the electronic provision system by the reader.

Prior to step 112, the reader may be configured to prompt the user to input at the reader to authenticate that the user has permission to receive the optical signal. For example, the initiation optical signal may include electronic vapor provision system identification data. The user may register the electronic vapor provision system on the remote network service 1300 such that the user is provided with an authentication message. The user may then be requested to provide the authentication message before accessing interpretation of the optical signal received. Thus, rather than any reader 400 receiving the optical signal being provided with an interpreted information of the optical signal data, only the valid user of the electronic vapor provision system is provided with such interpretation and is able to access services relating to the electronic vapor provision system on the remote network service 1300.

In step 113, the reader may communicate with a remote network service to interpret the optical signal. For example, the reader may access the database of the remote network service to match the optical signal data with the corresponding message to interpret the received optical signal.

In step 114, the reader 400 is configured to represent the interpreted information of the received optical signal at an output of the reader. For example, the optical signal may convey the error codes of the electronic vapor provision system. The error code may further include instructions for modifying the operation of the electronic vapor provision system to overcome the error that has been identified in the electronic vapor provision system. Such instructions may be output as a graphical/audio output by the reader 400.

An app may run on the reader 400 to assist in detecting and filtering any noise in the received optical signal so that optical signal data is better received. The app may also provide user friendly interface for the user to access further data. For example, as the electronic vapor provision system has limited space, the user may not be provided with a lot of control over which data is transferred via the relevant optical signal. In this case, all the data may be communicated to the reader 400 by the optical signal and uploaded to the database of the remote network service, and the user may then navigate around the database to access the relevant data using the interface of the app.

In some embodiments, where the total puff duration or the number of puff count reaches a threshold, the remote network service may be configured to automatically order new cartridges.

Other various actions may be initiated by the reader device depending on the information of the received data. For example, if the received data is an error code indicating which error has occurred in the electronic vapor provision system, the relevant error message may be displayed on the reader device along with possible configuration for the user to carry out in order to address the error. Further, depending on the error code, an option to contact an administrator of the remote network service 1300. Such administrator may be a support team of the provider and/or manufacturer of the electronic vapor provision system.

Data relating to error codes of the electronic vapor provision system may be particularly useful to the administrator of the remote network service 1300. For example, the administrator is able to obtain a real-time overview and history of any failure that various types of electronic vapor provision system is prone to. In addition, the users are provided with immediate response or assistance as soon as an error occurs in the electronic vapor provision system, thus providing a more reliable electronic vapor provision system, without requiring significant modifications to pre-existing electronic vapor provision system.

The received data which represent the information relating to the status of the electronic vapor provision system may further be uploaded to a database assigned to the user of the electronic vapor provision system.

Transferring data by optical signal enables unidirectional communication. It is noted that bidirectional communication (for example to reset or unlock the e-cigarette or to control settings on the e-cigarette) may be provided by using wired connection, for example by connection via a USB link using a micro, mini, or ordinary USB connection into the e-cigarette.

The USB link may be used, for example, to load control parameters and/or updated software onto the e-cigarette from an external source. Alternatively or additionally, the interface may be utilized to download data from the e-cigarette to an external system, such as the remote network service. The downloaded data may, for example, represent usage parameters of the e-cigarette, fault conditions, etc. As the skilled person will be aware, many other forms of data can be exchanged between an e-cigarette and one or more external systems (which may be another e-cigarette).

Note that many e-cigarettes already provide support for a USB interface in order to allow the e-cigarette to be re-charged. Accordingly, the additional use of such a wired interface to also provide data communications is straightforward. Furthermore, communication using optical signals can be achieved by utilizing an output of the e-cigarette which may in some devices already exist. It is very efficient to use a pre-existing component of the e-cigarette, particularly a component that is ubiquitous to most e-cigarettes. Even where IR LED is used, optical signal uses less energy than other forms of wireless communication, such as Bluetooth or Wifi. Thus, a more energy efficient communication method is achieved. Furthermore, LEDs are less complex to control than Bluetooth or Wifi. Accordingly, a simpler product is provided.

As wired communication is safer than a wireless communication, and the wireless communication is achieved by unidirectional communication, a safer communication is enabled. In other words, the possibility of any external interference or virus entering via wireless communication is removed. Such external interference or virus can be dangerous as the e-cigarette configuration could be meddled with so that the heat control is not achieved, or the heater is turned on when the user is not using the e-cigarette.

It is noted that a wireless connection can be useful in that a user does not need any additional cabling to form such a connection. In addition, the user has more flexibility in terms of movement, setting up a connection, and the range of pairing devices. Thus, the user can be provided with both the wired and wireless communication options.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein. The disclosure may include other inventions not presently claimed, but which may be claimed in future.

1. An electronic vapor provision system, comprising:
a light source configured to emit light; and
a controller comprising a data processor configured to generate transmission data, wherein the controller is configured to control the light source to emit an optical signal for transmitting the transmission data.

2. An electronic vapor provision system according to claim 1, in which the transmission data is based on data relating to the electronic vapor provision system retrieved from a data storage of the electronic vapor provision system.

3. An electronic vapor provision system according to claim 1, in which the transmission data comprises data relating to at least one element selected from the group comprising:
electronic vapor provision system usage;
unique electronic vapor provision system identifier; and
error codes.

4. An electronic vapor provision system according to claim 3, wherein the error codes include instructions for modifying the operation of the electronic vapor provision system to overcome the error that has been identified in the electronic vapor provision system.

5. An electronic vapor provision system according to claim 1, wherein the light source comprises an infrared light emitting diode.

6. An electronic vapor provision system according to claim 1, wherein the light source flashes on and off in a binary manner at a predetermined frequency to emit the optical signal.

7. An electronic vapor provision system according to claim 1, wherein the optical signal comprises an initiation portion and a main portion.

8. An electronic vapor provision system according to claim 7, wherein the initiation portion starts an authentication process.

9. An electronic vapor provision system according to claim 1, wherein the emission of the optical signal is initiated when a condition is met by the electronic vapor provision system.

10. An electronic vapor provision system according to claim 9, wherein the condition includes at least one of: an error identified in the electronic vapor provision system; and after a threshold of usage data is reached, wherein the usage data include at least one of puff counts, total puff duration.

11. An electronic vapor provision system according to claim 1, wherein the emission of the optical signal is initiated manually by the user.

12. A system comprising:
an electronic vapor provision system according to claim 1; and
a reading device comprising:
an optical signal receiver configured to receive the optical signal emitted from the electronic vapor provision system, and
a data processor configured to interpret the received optical signal.

13. A system according to claim 12, wherein the data processor is configured to access a remote network service.

14. A system according to claim 13, wherein the data processor is configured to interpret the received optical signal by matching the received optical signal with a corresponding message in a database of the remote network service.

15. A system according to claim 13, wherein the data processor is configured to update the remote database for data collection in the remote network service.

16. A system according to claim 1, wherein the reading device comprises display means configured to represent the interpreted information of the optical signal to a user.

17. A system according to claim 13, wherein the remote network service is configured to update the database relating to the user based on the received optical signal data.

18. A method comprising:
generating transmission data at an electronic vapor provision system;
emitting an optical signal for transmitting the transmission data from the electronic vapor provision system;
receiving the emitted optical signal at a reading device; and
processing received optical signal for interpreting the received transmission data.
